(19) United States
(12) Patent Application Publication
(10) Pub. No.: US 2002/0172802 A1
(43) Pub. Date: Nov. 21, 2002

(54) Decorative creped shredded material

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 09/902,983

(22) Filed: Jul. 11, 2001

Related U.S. Application Data
(63) Continuation of application No. 09/656,205, filed on Sep. 6, 2000, now abandoned.
Application No. 09/656,205 is a continuation of application No. 09/137,904, filed on Aug. 20, 1998, now abandoned.

(51) Int. Cl. B32B 1/00; B32B 23/02; B32B 31/00

(52) U.S. Cl. 428/152; 428/194; 156/265

(57) ABSTRACT

A decorative shredded material formed from a creped optical effect material made from a creped iridescent material, the creping creating light-reflective iridescent ridges and non-light reflective valleys on each strip or piece of the decorative shredded material. Methods for making decorative shredded material.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to decorative material and, particularly, to decorative creped shredded material and the methods of creating such a material.

2. Description of Related Art Including Information Disclosed Under 37 CFR §1.97 and 37 CFR §1.98

Sheets of material have been cut to form shredded material, first for packing purposes, later for decorative purposes. One decorative shredded material, a decorative grass formed from shredded plastic sheets, is disclosed in U.S. Pat. No. 4,199,627. A process for forming plastic sheets into a decorative grass is shown in U.S. Pat. No. 4,292,266. Compositions for forming a decorative grass, discussing pigments used to color such a grass, are disclosed in U.S. Pat. Nos. 4,401,700, 4,496,614 and 4,549,908.

Iridescent material is used in decorative wrapping material and sometimes, also, in glitter, and the like. Iridescent material is desirable for use in decorative gifts and wrapping because of its multi-color effect. Iridescent films and articles are known in the art. Iridescent films and articles, and the methods of making such films and articles, are disclosed in the following U.S. patents: U.S. Pat. No. 3,231,645, entitled “Method of Making Iridescent Plastic Sheets,” issued to Bolomey on Jan. 25, 1966; U.S. Pat. No. 3,481,663, entitled, “Iridescent Articles and Methods of Manufacture”, issued to Greenstein on Dec. 12, 1969; U.S. Pat. No. 4,162,343, entitled “Multilayer Light-Reflecting Film”, issued to Wilcox et al. on Jul. 24, 1979; U.S. Pat. No. RE31,780, entitled “Multilayer Light-Reflecting Film”, issued to Cooper et al. on Dec. 25, 1984; U.S. Pat. No. 5,008,143, entitled, “Decorative Objects With Multi-Color Effects”, issued to Armanini on Apr. 16, 1991; U.S. Pat. No. 5,089,318, entitled, “Iridescent Film With Thermoplastic Elastomeric Components”, issued to Shetty et al. on Feb. 18, 1992, and U.S. Pat. No. 5,154,765, entitled, “Decorative Objects With Multicolor Effects”, issued to Armanini on Oct. 13, 1992.

Creping of gift wrapping material is known in the art. Creping of a material results in the material being left with a wrinkled textured effect disposed substantially across the material.

The present invention contemplates creping an iridescent material. A smooth iridescent material, when exposed to light, shows its iridescence by reflecting the light back, showing a solid area of iridescence. When such a material is creped, it creates areas of high-lighted iridescence, where the light shines off of the ridges formed in the material, but also areas of darkness, such as in the valleys created by such creping, where the light is not reflected. Such an effect creates not just a textured effect, as creping is known to do, but also an interesting light reflective effect of “ridges and valleys”; that is, iridescent, color-changing ridges are interspersed with dark, non-light reflective valleys. This is a new and unusual decorative effect, especially when applied to a decorative shredded material (i.e., an iridescent creped material that is then shredded into decorative grasses or filamentary portions).

The prior art discloses using sheets of material to shred into shredded material, methods of creping material, and iridescent material. The prior art does not disclose an iridescent material which is creped to create the combination of unusual light and textural effects described previously, then shredded into a decorative, light-reflecting shredded material.

There is a need in the art for a sheet of material having ridges of iridescent effects interspersed with non-reflecting valleys of darkness formed by creping, then shredded into a new decorative shredded material, whose light reflecting iridescent effects changes with how the light falls on such ridges and valleys created by the creping process.

### BRIEF SUMMARY OF THE INVENTION

The decorative shredded material, comprises a substantially iridescent sheet of material having an upper surface and a lower surface. Both the upper surface and the lower surface are substantially creped. The sheet of material is shredded into a plurality of decorative strips. Each of the plurality of decorative strips retains a creped appearance forming a textured appearance of a plurality of ridges and valleys. The plurality of ridges and valleys creates visual light and dark reflective effects. A light reflective effect is created from light striking the ridges creating light-reflective iridescence. A dark reflective effect is created from non-light reflective valleys. The light and dark reflective effects change with a change in light directed upon and reflected from the plurality of ridges and valleys on each of the plurality of decorative strips.

An alterative decorative shredded material is disclosed, which comprises a substantially iridescent sheet of material having an upper surface and a lower surface. Both the upper surface and the lower surface are substantially creped. The sheet of material is then shredded into a plurality of decorative elements. Each of the plurality of decorative elements retains a creped appearance forming a textured appearance of a plurality of ridges and valleys which creates visual light and dark reflective effects. A light reflective effect is created from light striking the ridges creating light-reflective iridescence. A dark reflective effect is created from non-light reflective valleys. The light and dark reflective effects change with a change in light directed upon and reflected from the plurality of ridges and valleys on each of the plurality of decorative elements.

A method for providing a decorative shredded material is disclosed. A substantially iridescent sheet of material having an upper surface and a lower surface is provided. The sheet of material is then creped such that both the upper surface and the lower surface are creped. A creped appearance forms a textured appearance of a plurality of ridges and valleys which creates visual light and dark reflective effects. A light reflective effect is created from light striking the ridges creating light-reflective iridescence. A dark reflective effect is created from non-light reflective valleys. The light and dark reflective effects change with a change in light directed upon and reflected from the plurality of ridges and valleys. The sheet of material is then shredded into a plurality of decorative strips. Each of the plurality of decorative strips has both a textured appearance of a plurality of ridges and valleys and visual light and dark reflective effects. The light and dark reflective effects change with a change in light directed upon and reflected from the plurality of ridges and valleys on each of the plurality of decorative strips.

An alternative method for providing a decorative shredded material is disclosed. A substantially iridescent sheet of material having an upper surface and a lower surface is provided. The sheet of material is then creped such that both the upper surface and the lower surface are creped. A creped appearance forms a textured appearance of a plurality of ridges and valleys which creates visual light and dark reflective effects. A light reflective effect is created from light striking the ridges creating light-reflective iridescence. A dark reflective effect is created from non-light reflective valleys. The light and dark reflective effects change with a change in light directed upon and reflected from the plurality of ridges and valleys. The sheet of material is then shredded into a plurality of decorative elements. Each of the plurality of decorative elements has both a textured appearance of a plurality of ridges and valleys and visual light and dark reflective effects. The light and dark reflective effects change with a change in light directed upon and reflected from the plurality of ridges and valleys on each of the plurality of decorative elements.

The decorative shredded material may comprise a bonding material. When the decorative shredded material comprises a bonding material, the bonding material may comprise at least a portion of a pattern. The bonding material may comprise an adhesive bonding material. Alternatively, the bonding material may comprise a cohesive bonding material. The sheet of material may be constructed from a material selected from the group consisting of paper, cellophane, foil, polymer film, fabric, fiber, burlap, cloth, and any combination thereof. The sheet of material may have characteristics selected from the group consisting of decorations, colorings, coatings, embossings, flockings, metallic finishes, pearlescent finishes, translucent finishes, transparent finishes, neon finishes, holographic finishes, holographic designs, opaque finishes, clear finishes, and any combination thereof. It will be understood that any of these additional variations and characteristics may occur with any or all of the above-described shredded decorative material and/or the methods of making such material.

### BRIEF DESCRIPTION OF THE SEVERAL VIEWS OF THE DRAWINGS

FIG. 1 is a perspective view of the sheet of material constructed in accordance with the present invention, showing an iridescent creped material, having a corner lifted showing the lower surface for illustration purposes only.

FIG. 2 is a top plan view of the upper surface of the first sheet of material constructed in accordance with the present invention.

FIG. 3 is a perspective view of a plurality of sheets of material constructed in accordance with the present invention forming a continuous roll of sheets, the roll partially unrolled to reveal at least one sheet of material.

FIG. 4 is a perspective view of a pad having a plurality of sheets of material constructed in accordance with the present invention, showing an edge of the top sheet lifted, exposing the next sheet for illustration purposes only.

FIG. 5 is a perspective view of a roll of sheets of material constructed in accordance with the present invention, showing a plurality of knife edges being actuated by an actuator into a first shredding direction to cut at least a portion of the roll of sheets of material into elongated decorative strips.

FIG. 6 is a perspective view of the roll of sheets of material of FIG. 5, but showing the plurality of knife edges being actuated by an actuator into a second cutting direction to cut the elongated decorative strips into smaller decorative elements.

### DETAILED DESCRIPTION OF THE INVENTION

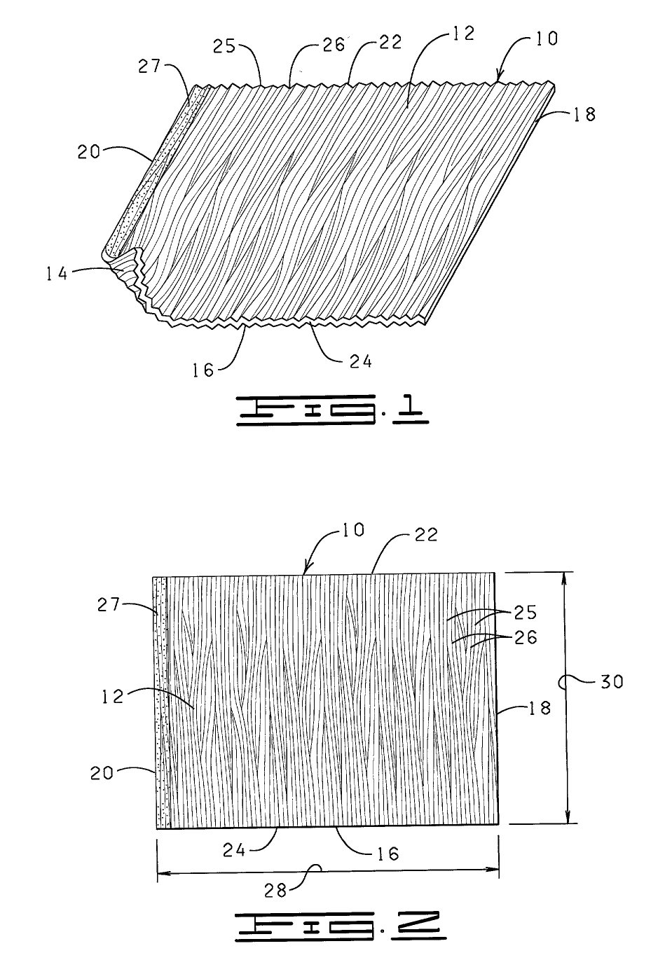

### The Embodiments of FIGS. 1-2

Decorative shredded material is frequently used as confetti, decorative grasses, tinsel, and the like (such decorative shredded material also being called, interchangeably herein, “grass” or “grasses” and/or “filamentary portions”), and is used to surround other items in various types of gift packages.

Iridescent material is sometimes used to make decorative shredded materials such as glitter, and the like. Iridescent material is used as decorative gift wrapping material as well, because of its changing, multi-color effect.

Creping material is known in the art. Creping creates a textured effect resembling a series of irregular ridges and valleys disposed substantially across the material.

The present decorative shredded material is formed from an iridescent creped material. Such a material creates areas of iridescence, where the light is reflected from the ridges formed in the material. Such a material also creates areas of darkness, such as in the valleys created by such creping, where the light is not reflected. Such an effect creates not just a textured effect, as creping is known to do, but also an interesting “ridges and valleys” visual effect of bright reflective iridescence ridges interspersed with dark, non-reflective valleys. This is a new and unusual decorative effect, especially when this material is shredded into a decorative shredded material, and each piece of the shredded material retains these interesting decorative effects. Further, these effects change as the material is moved under the light, creating iridescent reflective effects of new ridges which fall under the light, and new dark valleys in which light is not reflected.

Turning now to the Figures, shown in FIGS. 1-2 and designated therein by the general reference numeral 10 is an iridescent creped sheet of material. The sheet of material 10 has an upper surface 12, a lower surface 14, and an outer periphery 16. As shown in FIGS. 1 and 2, the outer periphery 16 further comprises a first side 18, a second side 20, a third side 22 and a fourth side 24. The sheet of material 10 is formed from a substantially iridescent material, and the sheet of material 10 is also substantially creped, to create a continuous textured pattern of a plurality of ridges 25 and valleys 26. Only one of the plurality of ridges is designated by the numeral 25; only one of the plurality of valleys is designated by the numeral 26.

A bonding material 27 may, optionally, be disposed on the sheet of material 10, on either the upper surface 12, the lower surface 14, or both surfaces. Alternatively, however, the sheet of material 10 may be free of a bonding material 27. As illustrated in FIG. 1, the bonding material 27, if present, is often disposed on the upper surface 12 of the sheet of material 10. The bonding material 27 may also be disposed in a strip of bonding material 27, as shown in FIGS. 1-2, although the bonding material 27 also could be applied to a surface of the sheet of material 10 in the form of spaced apart spots or the bonding material 27 may be disposed on one or more surfaces of the sheet of material 10 in any geometric, non-geometric and/or asymmetric shape, or any combination thereof, including any pattern or plurality of patterns. Further, the bonding material may form at least a part, or, alternatively, all of the pattern on each sheet of material and/or each strip of material. In this instance, the bonding material 27 may comprise one or more colors; the bonding material 27 may comprise one or more patterns as well. Such a colored or tinted bonding material is disclosed in U.S. Pat. No. 5,347,789, entitled, “Decorative Material Having A Colored Sticky Element Disposed Thereon Forming At Least A Portion Of A Decoration And Method”, issued to Donald E. Weder, on Sep. 20, 1994, which is hereby incorporated by reference.

It will also be understood that the bonding material 27 may not be applied to the sheet of material 10 until the sheet of material 10 is shredded into a decorative shredded material, as described in detail below. Alternatively, however, it will be appreciated that the bonding material 27 may be applied to the sheet of material 10 prior to such shredding.

Turning now to the characteristics of the sheet of material 10 used to form the decorative shredded material, the sheet of material 10 is formed from a flexible material and has a thickness in a range from about 0.1 mils to about 10 mils. Often, the sheet of material 10 has a thickness in a range from about 0.2 mils to about 5 mils. The sheet of material 10 also often has a thickness in a range from about 0.2 mils to about 3.5 mils. In some embodiments, the sheet of material 10 has a thickness in a range from about 0.5 mils to about 2.5 mils. In other embodiments, the sheet of material 10 has a thickness in a range from about 0.7 mils to about 2.0 mils.

The sheet of material 10 may comprise any shape or combination of shapes, and a rectangular shape is shown in FIG. 1 only by way of example. The sheet of material 10 for example may be square, rectangular, circular or any other geometric, non-geometric, asymmetric or fanciful shape. The sheet of material 10 may be constructed of a single layer of material or a plurality of layers of the same or different types of materials. The layers of material comprising the sheet of material 10 may be laminated together or connected together by any method known in the art.

When the sheet of material 10 is constructed from several layers, the layers may comprise primarily layers which create the iridescent sheet of material. An often used iridescent film formed from multiple layers is IF-8531 R/S, manufactured by Mearl Corporation, 1050 Lower South Street, Peekskill, N.Y., 10566.

Iridescent films and articles are known in the art. Iridescent films and articles, and the methods of making such films and articles, are disclosed in the following U.S. patents: U.S. Pat. No. 3,231,645, entitled “Method of Making Iridescent Plastic Sheets,” issued to Bolomey on Jan. 25, 1966; U.S. Pat. No. 3,481,663, entitled, “Iridescent Articles and Methods of Manufacture”, issued to Greenstein on Dec. 12, 1969; U.S. Pat. No. 4,162,343, entitled “Multilayer Light-Reflecting Film”, issued to Wilcox et al. on Jul. 24, 1979; U.S. Pat. No. RE31,780, entitled “Multilayer Light-Reflecting Film”, issued to Cooper et al. on Dec. 25, 1984; U.S. Pat. No. 5,008,143, entitled, “Decorative Objects With Multi-Color Effects”, issued to Armanini on Apr. 16, 1991; U.S. Pat. No. 5,089,318, entitled, “Iridescent Film With Thermoplastic Elastomeric Components”, issued to Shetty et al. on Feb. 18, 1992, and U.S. Pat. No. 5,154,765, entitled, “Decorative Objects With Multicolor Effects”, issued to Armanini on Oct. 13, 1992; all of the foregoing patents are hereby incorporated by reference herein.

In other embodiments, it has been discovered that a film having less cost may be manufactured using a very thin (about 0.4 mils to about 0.9 mils) iridescent film laminated to a clear, colorless, or tinted film. In this instance, the clear film acts as a light transmitting film, transmitting the light through the clear film to the iridescent film, so that the films, in a laminated arrangement connected together, appear iridescent on each surface of the connected film. Such a clear, colorless film is often a plastic film obtained from, for example, Vifan BT medium slip biaxially oriented polypropylene film (clear), available from Vifan Canada, Inc., Vifan street, Lanoraie d'Autray, Quebec, Canada JOK 1EO. An alternative plastic film (Hercules B523 oriented polypropylene packaging film (clear)), is available from Hercules Incorporated, Hercules Plaza, Wilmington, Del. 19894. Laminating an iridescent film to a clear film is disclosed in U.S. Pat. No. 5,576,089, entitled “Optical Effect Material And Methods”, issued to D. Weder Nov. 19, 1996, which is hereby incorporated by referenced herein.

In one embodiment, the sheet of material 10 is a thin, flexible material constructed from an iridescent polymer film. Alternatively, such an iridescent polymer film may be utilized, alone, or in combination, with other sheets of material described herein. In this instance, as discussed herein, such sheets of material may be laminated together or may be connected together by any method known in the art, or may remain partially or completely unconnected.

The sheet of material 10 shown in FIG. 1 is constructed from at least one sheet of iridescent material which is creped, and which is also capable of being shredded. The sheet of material 10 must be capable of being shredded without any substantial tearing or degradation by such shredding. Further, the sheet of material 10 must be capable of being shredded into decorative shredded material, such as, but not by way of limitation, confetti, grass, tinsel, glitter, flakes, and the like.

As described above, the sheet of material 10 comprises at least a polymer film which is iridescent. The sheet of material 10 may also comprise paper (the term “paper” as used herein means treated or untreated paper, corrugated paper or cardboard or any other form of paper material). The sheet of material 10 may comprise cellophane, foil, plastic film, metallized film, fabric (woven or nonwoven or synthetic or natural), fiber, burlap, or any combination thereof.

The terms “polymer film” and “plastic film” as used herein means a thermo-plastic resinous material, such as, but not by way of limitation, a man-made polymer such as, but not by way of limitation, a polypropylene. The terms “polymer film” and “plastic film” as used herein also mean a naturally occurring polymer such as cellophane. A plastic film, as contemplated and described in detail herein, is relatively strong and not as subject to tearing (substantially non-tearable), as might be the case with paper or foil.

The sheet of material 10 has a length 28 extending between the first and second sides 18 and 20 of the sheet of material 10. The sheet of material 10 also has a width 30 extending between the third and fourth sides 22 and 24 of the sheet of material 10.

The sheet of material 10 may be constructed of a single layer of material or a plurality of layers of the same or different types of materials. One or more sheets of material are laminated or bonded together, completely or partially, by any method known in the art, so long as the end result is a sheet of material 10 having the characteristics previously described herein and the ability to be shredded into decorative shredded strips of material. It will therefore be appreciated that multiple sheets of material 10 may be used. Moreover, when multiple sheets of material 10 are used, the sheets of material 10 need not be uniform in size or shape. That is, one sheet may extend beyond at least a portion of the outer periphery of another sheet of material.

As noted earlier, a bonding material 27 may be disposed on the sheet of material 10, in any pattern or shape. One method for disposing a bonding material, in this case an adhesive, on a sheet of material is described in U.S. Pat. No. 5,111,637 entitled “Method For Wrapping A Floral Grouping” issued to Weder et al., on May 12, 1992 and which is hereby incorporated herein by reference. Another method for disposing a bonding material in order to laminate two sheets of material is described in U.S. Pat. No. 4,297,811 entitled “Laminated Printed Foil Flower Pot Wrap With Multicolor Appearance, issued to Weder on Nov. 3, 1981, which is also hereby incorporated herein by reference.

The term “bonding material” when used herein means an adhesive, possibly a pressure sensitive adhesive, or a cohesive. Where the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” when used herein also means a lacquer, which may be applied to the sheet of material and, in this instance, heat, sound waves, or vibrations, also must be applied to effect the sealing of the lacquer.

The sheet of material 10 may also consist of designs or decorative patterns which are printed, etched, and/or embossed thereon using inks or other printing materials (not shown). An example of an ink which may be applied to either surface of the sheet of material 10 is described in U.S. Pat. No. 5,147,706 entitled “Water Based Ink On Foil And/Or Synthetic Organic Polymer” issued to Kingman on Sep. 15, 1992 and which is hereby incorporated herein by reference.

In addition, the sheet of material 10 may have various colorings, coatings, embossings, flockings and/or metallic finishes, or other decorative surface ornamentation applied separately or simultaneously. The sheet of material 10 may also have other characteristics, which include, but not by way of limitation, pearlescent, translucent, transparent, tinted, clear, iridescent, opaque, neon, holographic, or the like, qualities and/or characteristics. Each of the above-named qualities and/or characteristics may occur alone or in combination with other characteristics described herein, and may be applied to the upper and/or lower surface of the sheet of material 10. Moreover, each surface of the sheet of material 10 may vary in the combination of such characteristics.

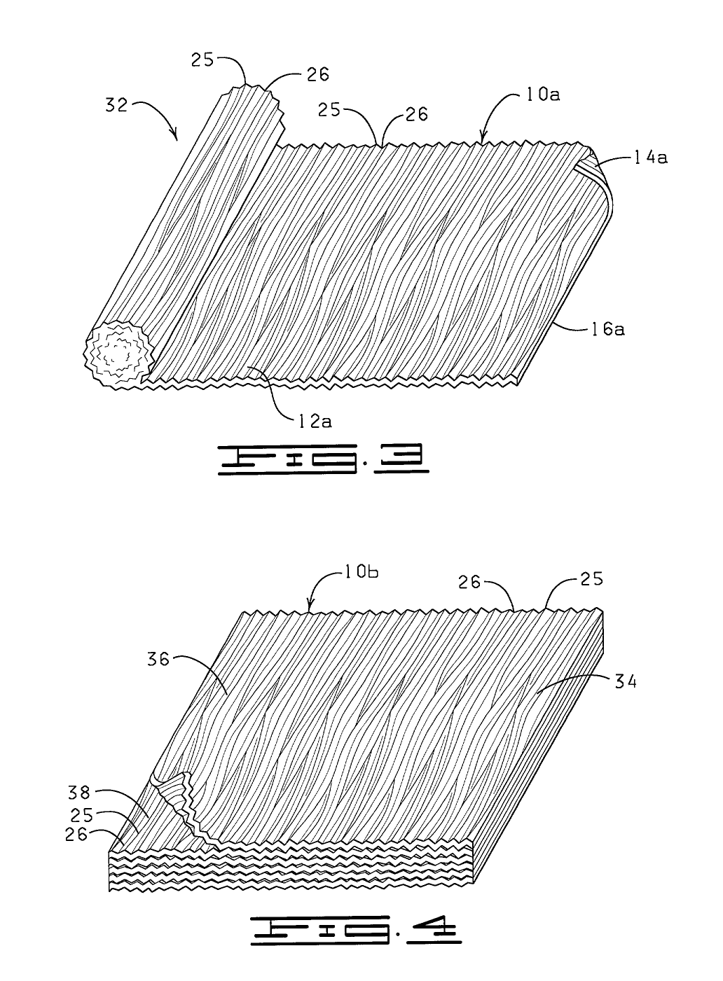

### Embodiment of FIG. 3

Referring now to FIG. 3, a plurality of individual sheets of material 10a are connected linearly together to form a roll 32. The plurality of sheets of material 10a in the roll 32 may be connected together by perforations (not shown). Such a roll 32 permits one sheet of material 10a to be withdrawn from the roll 32, then severed or disconnected from the roll 32. As shown in FIG. 3, the roll 32 is often formed as a continuous roll 32 of sheets of material 10a, wherein a plurality of sheets of material 10a may be removed from the roll 32 by unrolling a portion of the roll 32, and using a separate cutting element (not shown) to sever the unrolled portion of the roll 32 of material (not shown). The roll 32 may also be contained within any type of dispenser (not shown). When the roll 32 is disposed in a dispenser, a portion of the material is again unrolled, and a cutting edge (not shown) contained within the dispenser, or a separate cutting element (not shown), severs the unrolled portion of the material. Any number of sheets of material 10a may form a roll 32 as long as it is possible to unroll the material into at least one sheet of material 10a.

### Embodiments of FIG. 4

Shown in FIG. 4 is a modified sheet of material lob which is identical to the sheet of material 10 shown in FIGS. 1-2 and described in detail previously, except that the sheet of material 10b is formed into sheets material 10b which are stacked and aligned, generally, but not by way of limitation, one on top of the other to form a pad 34 of sheets of material 10b.

The pad 34 comprises a top sheet 36 having a next sheet 38 disposed directly thereunder, with additional sheets of material 10b disposed under the next sheet 38, all sheets collectively forming the pad 34 of sheets of material 10b (one edge of the top sheet 36 lifted for illustration purposes only). The sheets of material 10b are generally aligned, and may, optionally, but not by way of limitation, be connected together via a bonding material (not shown), such as, but not by way of limitation, a pressure sensitive adhesive.

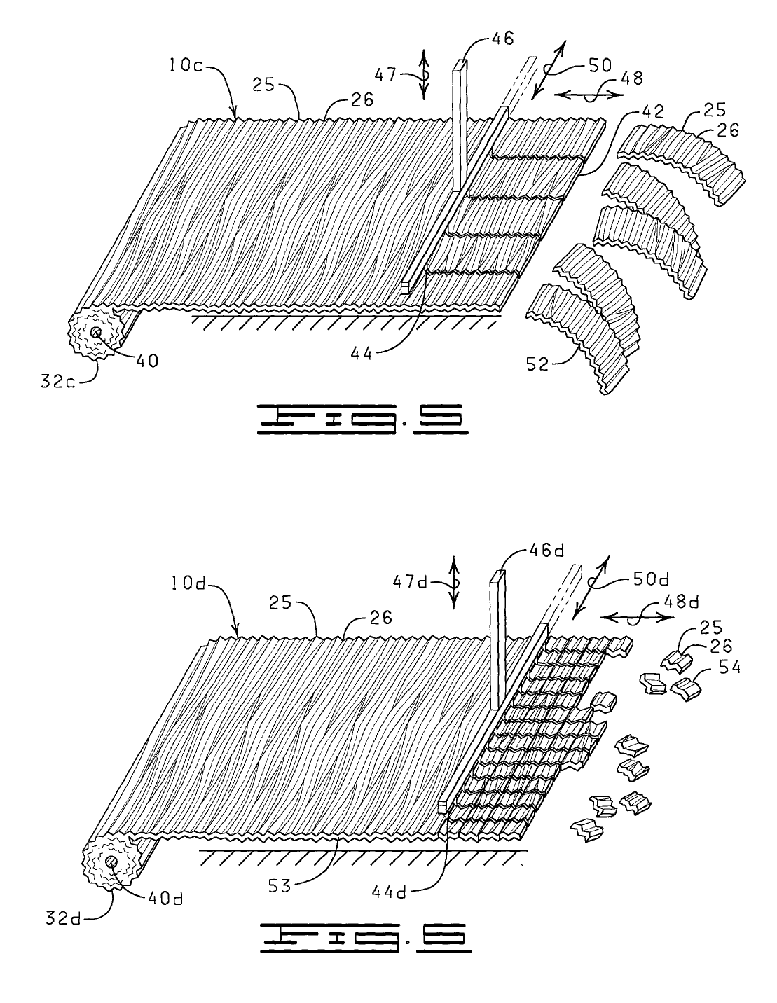

### Embodiments and Methods of FIG. 5

Shown in FIG. 5 is a modified roll 32c of sheets of material 10c. The roll 32c of sheets of material 10c is constructed exactly like the roll 32 of sheets of material 10a described before, except the roll 32c is supported on a generally mounted shaft 40. At least one sheet of material 10c is withdrawn from the roll 32c via a leading edge 42 until a predetermined length of the sheet of material 10c has been withdrawn from the roll 32c. In this position, a portion of the sheet of material 10c is disposed under a plurality of knife edges 44 (only one of the plurality of knife edges designated by the numeral 44). The plurality of knife edges 44 are connected to an actuator 46 adapted to move the plurality of knife edges 44 into an engagement position 47 with the sheet of material 10c. In the engagement position 47, the actuator 46 moves the plurality of knife edges 44 in a first shredding direction 48 to produce a plurality of elongated decorative strips 52 from the sheet of material 10c. The actuator 46 also moves the plurality of knife edges 44 in a second cutting direction 50, so that each of the elongated decorative strips 52 may be severed from the sheet of material 10c. When the predetermined length of the sheet of material 10c has been withdrawn from the roll 32c, the actuator 46 actuates to move the plurality of knife edges 44 in the first shredding direction 48 to a position wherein the knife edge 44 cuttingly and severingly engages the sheet of material 10c to shreddingly cut a plurality of elongated decorative strips 52 of the sheet of material 10c and to sever the plurality of elongated strips 52 from the sheet of material 10c.

### Embodiments and Methods of FIG. 6

Shown in FIG. 6 is a modified roll 32d of sheets of material 10d. The roll 32d of sheets of material 10d is constructed exactly like the roll 32 and 32c of sheets of material 10a and 10c described previously, except that the sheet of material 10d is severed into a plurality of small pieces. The sheet of material 10d is supported on a generally mounted shaft 40d. At least one sheet of material 10d is withdrawn from the roll 32d via a leading edge 42d (not shown) until a predetermined length of the sheet of material 10d has been withdrawn from the roll 32d. In this position, a portion of the sheet of material 10d is disposed under a plurality of knife edges 44d as described above. The plurality of knife edges 44d are connected to an actuator 46d adapted to move the plurality of knife edges 44d into an engagement position 47d with the sheet of material 10d. In the engagement position 47d, the actuator 46d moves the plurality of knife edges 44d in a first shredding direction 48d to produce a plurality of short strips (only one of the plurality being referenced by the numeral “53”) from the sheet of material 10d. The actuator 46d then turns the plurality of knife edges 44d into to a second cutting direction 50d wherein the plurality of knife edges 44d which first cut the plurality of short strips 53 via the first shredding direction 48d now cuttingly and severingly re-engages the plurality of short strips 53 to cut the plurality of short strips 53 into small pieces. In this second cutting direction 50d, as described, the plurality of short strips 53 are further severed into small pieces, for use as, but not by way of limitation, confetti, and the like, for example. These small pieces are collectively referred to herein as “decorative elements” and are designated by the numeral 54.

It will be appreciated that, rather than a roll 32 of sheets of material 10, a pad (not shown) of sheets of material 10 also could be provided, and the actuator 46 and the plurality of knifed edges 44 could be adapted such that the pad of sheets of material 10 could be cut thereby forming decorative strips 52 and/or decorative elements 54, as illustrated herein and described in detail.

It will be understood that the mechanical process of forming such decorative strips 52 or decorative elements 54 is represented only schematically in the drawings. The actuator 46 may comprise a hydraulic or pneumatic cylinder or a motor and gear arrangement or any other form of arrangement suitable for moving the plurality of knife edges 44 in the first shredding direction 48 and/or the second cutting direction 50. After the knife edge 44 has cuttingly severed the desired portion of the sheet of material 10 from the roll 32 or a pad 34 (not shown), the actuator 46 is actuated to move the plurality of knife edges 44 in a storage direction (not shown) to a storage position (not shown). Alternatively, the leading edge 42 may be directed across a first plurality of knife edges 44 (not shown) set in the surface to form the decorative strips 52, wherein the actuator 46 actuates a second plurality of knife edges 44 (not shown) to cross-cut the elongated decorative strips 52 into decorative elements 54 (not shown). Apparatus and methods for making decorative shredded materials and the like is disclosed in U.S. Pat. No. 4,646,388, entitled, “Apparatus For Producing Weighed Charges Of Loosely Aggregated Filamentary Material”, issued to Weder et al. on Mar. 3, 1987, which is hereby incorporated by reference herein. Another process for forming decorative shredded material into decorative grass is disclosed in U.S. Pat. No. 4,292,266, entitled, “Process For Making Decorative Grass”, issued to Weder et al. on Sep. 29, 1981, which is also hereby incorporated by reference herein. Yet another decorative grass is shown and described in U.S. Pat. No. 4,199,627, entitled, “Decorative Grass”, issued to Weder et al. on Apr. 22, 1980, is hereby incorporated by referenced herein, also. Compositions used for forming decorative grass are disclosed in U.S. Pat. Nos. 4,401,700, 4,496,614 and 4,549,908, entitled, collectively, “Composition For Decorative Grass”, issued to Weder et al. on Aug. 30, 1983, Jan. 29, 1985, and Oct. 29, 1985, respectively, all of which are hereby incorporated by reference herein.

Changes may be made in the construction and the operation of the various components, elements and assemblies described herein or in the steps or the sequence of steps of the methods described herein without departing from the spirit and scope of the invention as defined in the following claims.

What is claimed is:

1. A decorative shredded material, comprising:
a substantially iridescent sheet of material having an upper surface and a lower surface, both the upper surface and the lower surface being substantially creped,
wherein the sheet of material is shredded into a plurality of decorative strips, each of the plurality of decorative strips retaining a creped appearance forming a textured appearance of a plurality of ridges and valleys which creates visual light and dark reflective effects, a light reflective effect created from light striking the ridges creating light-reflective iridescence and a dark reflective effect being created from non-light reflective valleys, the light and dark reflective effects changing with a change in light directed upon and reflected from the plurality of ridges and valleys on each of the plurality of decorative strips.

2. The decorative shredded material of claim 1 wherein the decorative shredded material further comprises a bonding material.

3. The decorative shredded material of claim 2 wherein the bonding material further comprises at least a portion of a pattern.

4. The decorative shredded material of claim 2 wherein the bonding material comprises an adhesive bonding material.

5. The decorative shredded material of claim 2 wherein the bonding material comprises a cohesive bonding material.

6. The decorative shredded material of claim 1 wherein the sheet of material is constructed from a material selected from the group consisting of paper, cellophane, foil, polymer film, fabric, fiber, burlap, cloth, and any combination thereof.

7. The decorative shredded material of claim 1 wherein the sheet of material is further defined as having characteristics selected from the group consisting of decorations, colorings, coatings, embossings, flockings, metallic finishes, pearlescent finishes, translucent finishes, transparent finishes, neon finishes, holographic finishes, holographic designs, opaque finishes, clear finishes, and any combination thereof.

8. A decorative shredded material, comprising:
a substantially iridescent sheet of material having an upper surface and a lower surface, both the upper surface and the lower surface being substantially creped,
wherein the sheet of material is shredded into a plurality of decorative elements, each of the plurality of decorative elements retaining a creped appearance forming a textured appearance of a plurality of ridges and valleys which creates visual light and dark reflective effects, a light reflective effect created from light striking the ridges creating light-reflective iridescence and a dark reflective effect being created from non-light reflective valleys, the light and dark reflective effects changing with a change in light directed upon and reflected from the plurality of ridges and valleys on each of the plurality of decorative elements.

9. The decorative shredded material of claim 8 wherein the decorative shredded material further comprises a bonding material.

10. The decorative shredded material of claim 9 wherein the bonding material further comprises at least a portion of a pattern.

11. The decorative shredded material of claim 9 wherein the bonding material comprises an adhesive bonding material.

12. The decorative shredded material of claim 9 wherein the bonding material comprises a cohesive bonding material.

13. The decorative shredded material of claim 8 wherein the sheet of material is constructed from a material selected from the group consisting of paper, cellophane, foil, polymer film, fabric, fiber, burlap, cloth, and any combination thereof.

14. The decorative shredded material of claim 8 wherein the sheet of material is further defined as having characteristics selected from the group consisting of decorations, colorings, coatings, embossings, flockings, metallic finishes, pearlescent finishes, translucent finishes, transparent finishes, neon finishes, holographic finishes, holographic designs, opaque finishes, clear finishes, and any combination thereof.

15. A method for providing a decorative shredded material, comprising:
providing a substantially iridescent sheet of material having an upper surface and a lower surface;
creping the sheet of material such that both the upper surface and the lower surface are creped, a creped appearance forming a textured appearance of a plurality of ridges and valleys which creates visual light and dark reflective effects, a light reflective effect created from light striking the ridges creating light-reflective iridescence and a dark reflective effect being created from non-light reflective valleys, the light and dark reflective effects changing with a change in light directed upon and reflected from the plurality of ridges and valleys; and
shredding the sheet of material into a plurality of decorative strips, each of the plurality of decorative strips having both a textured appearance of a plurality of ridges and valleys and visual light and dark reflective effects, the light and dark reflective effects changing with a change in light directed upon and reflected from the plurality of ridges and valleys on each of the plurality of decorative strips.

16. The method of claim 15 wherein in the step of providing a substantially iridescent sheet of material, the sheet of material is further defined as comprising a bonding material.

17. The method of claim 16 wherein the bonding material further comprises at least a portion of a pattern.

18. The method of claim 16 wherein the bonding material comprises an adhesive bonding material.

19. The method of claim 16 wherein the bonding material comprises a cohesive bonding material.

20. The method of claim 15 wherein in the step of providing a substantially iridescent sheet of material, the sheet of material is further defined as being constructed from a material selected from the group consisting of paper, cellophane, foil, polymer film, fabric, fiber, burlap, cloth, and any combination thereof.

21. The method of claim 15 wherein in the step of providing a substantially iridescent sheet of material, the sheet of material is further defined as having characteristics selected from the group consisting of decorations, colorings, coatings, embossings, flockings, metallic finishes, pearlescent finishes, translucent finishes, transparent finishes, neon finishes, holographic finishes, holographic designs, opaque finishes, clear finishes, and any combination thereof.

22. A method for providing a decorative shredded material, comprising:
providing a substantially iridescent sheet of material having an upper surface and a lower surface;
creping the sheet of material such that both the upper surface and the lower surface are creped, a creped appearance forming a textured appearance of a plurality of ridges and valleys which creates visual light and dark reflective effects, a light reflective effect created from light striking the ridges creating light-reflective iridescence and a dark reflective effect being created from non-light reflective valleys, the light and dark reflective effects changing with a change in light directed upon and reflected from the plurality of ridges and valleys; and
shredding the sheet of material into a plurality of decorative elements, each of the plurality of decorative elements having both a textured appearance of a plurality of ridges and valleys and visual light and dark reflective effects, the light and dark reflective effects changing with a change in light directed upon and reflected from the plurality of ridges and valleys on each of the plurality of decorative elements.

23. The method of claim 22 wherein in the step of providing a substantially iridescent sheet of material, the sheet of material is further defined as comprising a bonding material.

24. The method of claim 23 wherein the bonding material further comprises at least a portion of a pattern.

25. The method of claim 23 wherein the bonding material comprises an adhesive bonding material.

26. The method of claim 23 wherein the bonding material comprises a cohesive bonding material.

27. The method of claim 22 wherein in the step of providing a substantially iridescent sheet of material, the sheet of material is further defined as being constructed from a material selected from the group consisting of paper, cellophane, foil, polymer film, fabric, fiber, burlap, cloth, and any combination thereof.

28. The method of claim 22 wherein in the step of providing a substantially iridescent sheet of material, the sheet of material is further defined as having characteristics selected from the group consisting of decorations, colorings, coatings, embossings, flockings, metallic finishes, pearlescent finishes, translucent finishes, transparent finishes, neon finishes, holographic finishes, holographic designs, opaque finishes, clear finishes, and any combination thereof.
